(19) United States
(12) Patent Application Publication
(10) Pub. No.: US 2017/0037967 A1
(43) Pub. Date: Feb. 9, 2017

(54) Selector Drum for a Shift Transmission of a Motor Vehicle, and Shift Transmission With Such a Selector Drum

(71) Applicant: Bayerische Motoren Werke Aktiengesellschaft, Muenchen (DE)

(72) Inventor: Wolfgang SEMET, Pfaffenhofen (DE)

(21) Appl. No.: 15/333,229

(22) Filed: Oct. 25, 2016

Related U.S. Application Data
(63) Continuation of application No. PCT/EP2015/055410, filed on Mar. 16, 2015.

(30) Foreign Application Priority Data
May 7, 2014 (DE) 10 2014 208 493.8

(51) Int. Cl. F16H 63/18; B62K 23/08

(52) U.S. Cl. CPC F16H 63/18; B62K 23/08

(57) ABSTRACT

A selector drum for a shift transmission of a motor vehicle includes a substantially cylindrical drum body which has a longitudinal axis and a guide groove on a radial outer face. An actuating pin of a selector fork of the shift transmission can engage into the guide groove. The guide groove has an active groove region, which defines an axial movement of the selector fork, and an inactive groove region, which defines an axially constant neutral position of the shift fork. A groove course at least of the active groove region of the guide groove is determined by parabola sections and/or a spline function.

### CROSS REFERENCE TO RELATED APPLICATIONS

This application is a continuation of PCT International Application No. PCT/EP2015/055410, filed Mar. 16, 2015, which claims priority under 35 U.S.C. §119 from German Patent Application No. 10 2014 208 493.8, filed May 7, 2014, the entire disclosures of which are herein expressly incorporated by reference.

### BACKGROUND AND SUMMARY OF THE INVENTION

The invention relates to a selector drum for a shift transmission of a vehicle, having a substantially cylindrical drum body which can be rotated about a longitudinal axis with a guide groove on a radial outer side. Into the guide groove, an actuating pin of a selector fork of the shift transmission can engage. The guide groove has an active groove region which defines an axial movement of the selector fork and an inactive groove region which defines an axially fixed neutral position of the selector fork. Moreover, the invention also includes a shift transmission of a motor vehicle having a selector drum of this type.

In motor vehicle shift transmissions, in particular claw-shifted or synchronized shift transmissions, a gear change takes place as a rule by way of movable selector forks, for example, sliding gears or selector sleeves of the shift transmission. Motorcycles are usually equipped with a sequential, claw-shifted transmission, in which the selector forks are displaced axially by way of a selector drum. Guide grooves are provided on a radial outer side of the selector drum, into which guide grooves in each case one actuating pin of a selector fork engages. By way of a rotational movement of the selector drum by a defined angle, the associated selector fork is displaced axially in the case of a suitable groove profile in the groove longitudinal direction, in such a way that the transmission shifts from one gear into another gear.

Selector drums with guide grooves are already known in general from the prior art, a course of the active groove region of the guide grooves in the developed view of the cylindrical circumferential face being fixed in the groove longitudinal direction by way of a combination of straight line and circular arc sections.

It is an object of the present invention to provide a selector drum which contributes in a motor vehicle shift transmission to a reduced-noise and, particularly, low-wear shifting operation.

According to the invention, this object is achieved by way of a selector drum of the type mentioned at the outset, in which selector drum a groove profile at least of the active groove region of the guide groove is fixed by way of parabola sections and/or a spline function. Whereas undesired acceleration and therefore force peaks occur at the respectively associated selector forks in the case of the guide grooves which are known from the prior art, a groove profile which is parabolic in sections in the developed view of the drum body leads, in the case of a rotational movement of the selector drum at a constant angular velocity, to an axial acceleration of the selector fork which is constant in sections. This contributes to a particularly low-noise and low-wear shifting behavior of the transmission. If the groove profile is assembled piece by piece from polynomials, the fundamental spline function is preferably selected in such a way that it results in sections in an approximately constant axial acceleration of the selector forks and, moreover, to continuous transitions and no non-continuous acceleration jumps in the area between the approximately constant acceleration sections.

A groove profile of the inactive groove region of the guide groove is preferably fixed by way of a straight line which extends perpendicularly with respect to the longitudinal axis and merges in a continuously differentiable manner into one of the parabola sections and/or the spline function. This means that undesired acceleration peaks of the respectively associated selector fork do not occur even in the transition region between an active groove region and an inactive groove region.

In one embodiment of the selector drum, a groove profile of the active groove region of the guide groove is fixed by way of parabola sections, preferably exclusively by way of parabola sections. The active groove region is assigned at least one selectable gear and each gear is assigned precisely four parabola sections. During a shifting operation of the shift transmission, the parabola sections ensure a speed profile which is linear in sections and an acceleration profile which is constant in sections of the associated selector fork. This has proven to be particularly advantageous in terms of noise and wear minimization. In each case two parabola sections are preferably provided for engaging and disengaging each gear, namely one parabola section for constant acceleration and one parabola section for constant braking of the selector fork.

In particular, a groove profile of the active groove region of the guide groove is fixed by way of parabola sections, all parabola sections preferably being congruent. This results in acceleration and retardation values which are always identical in terms of magnitude during a shifting operation of the associated selector fork.

In a further embodiment of the selector drum, a groove profile of the active groove region of the guide groove is fixed in the groove longitudinal direction by way of an at least second-degree spline function. Spline functions of this type are assembled piece by piece from at least second-degree polynomials and are also continuously differentiable at the transition points of two polynomial pieces. In relation to the acceleration of the selector fork, this makes an acceleration profile which is largely constant in sections and an advantageous continuous transition between the largely constant acceleration sections possible.

Otherwise, the object is also achieved according to the invention by way of a shift transmission of a motor vehicle having the above-described selector drum and at least one selector fork which has an actuating pin, the actuating pin engaging into the guide groove of the selector drum.

The shift transmission is particularly preferably a foot-actuated, sequential shift transmission of a motorcycle.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a detail of a conventional shift transmission in a perspective exploded view with a conventional selector drum; and

FIG. 2 is a graphical detail of the developed view of a selector drum according to an embodiment of the invention in the region of a guide groove.

### DETAILED DESCRIPTION OF THE DRAWINGS

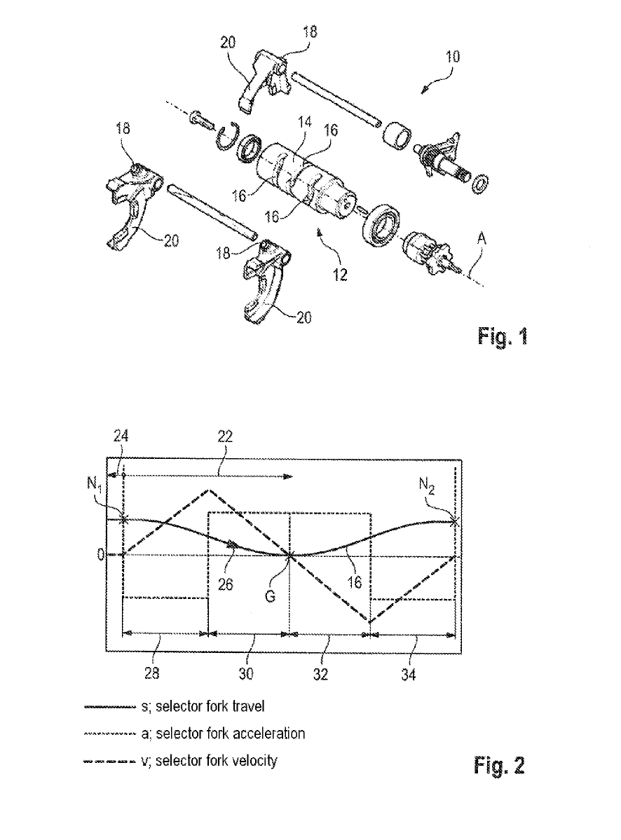

FIG. 1 shows a detail of a conventional shift transmission 10, specifically of a foot-actuated, sequential shift transmission 10 of a motorcycle.

The shift transmission 10 includes a selector drum 12 with a cylindrical drum body 14 which can be rotated about a longitudinal axis A. The cylindrical drum body 14 has a guide groove 16 on a radial outer side, into which guide groove 16 an actuating pin 18 of a selector fork 20 of the shift transmission 10 can engage. Moreover, the shift transmission 10 includes at least one selector fork 20 which has an actuating pin 18, said actuating pin 18 engaging into the guide groove 16 of the selector drum 12 in the assembled state of the shift transmission 10.

In the exemplary embodiment which is shown, three selector forks 20 are provided which are assigned in each case two gears, with the result that the shift transmission 10 is a six gear transmission of a motorcycle.

Each selector fork 20 of the shift transmission 10 is assigned a guide groove 16 in the selector drum 12, with the result that the drum body 14 according to FIG. 1 comprises three guide grooves 16.

Each guide groove 16 has what is known as an “active” groove region 22 which defines an axial movement of the associated selector fork 20 and what is known as an “inactive” groove region 24 which defines an axially fixed neutral position of the selector fork 20. Accordingly, in the developed view of the drum body 14, a groove profile of the inactive groove region 24 of the guide groove 16 is fixed in the groove longitudinal direction 26 by way of a straight line which extends perpendicularly with respect to the longitudinal axis A.

Since the construction and method of operation of sequential shift transmissions 10 of this type are generally known, they will not be described in greater detail in the following text.

In conventional drum bodies, the guide grooves are assembled in the developed view from straight and circularly arcuate groove sections. In the case of a rotational movement of the selector drum 12 about the longitudinal axis A at a constant angular velocity, the circular arc sections generate axial acceleration and therefore force peaks in the respectively associated selector fork 20. This leads both to undesirably loud shifting noise and undesirably high wear of the shift transmission, as well as to an impairment of the shifting comfort, which is considered to be unpleasant by the rider.

A selector drum 12 according to the invention differs from the selector drum 12 according to FIG. 1 exclusively as a result of a groove profile s of the guide groove 16 which will be described in greater detail in the following text.

FIG. 2 shows a detail of the developed view of the drum body 14 of a selector drum 12 according to the invention in the region of a guide groove 16. Here, the groove profile s of the guide groove 16 is shown as a solid line, whereas an axial velocity v and an axial acceleration a of the associated selector fork 20 for a rotational movement of the selector drum 12 at a constant angular velocity are depicted using dashed and dotted lines. If a coordinate system is superimposed on FIG. 2, in which a circumference of the drum body 14 is plotted on the abscissa, the ordinate of the groove profile s represents the axial displacement of the selector fork 20.

It is essential to the invention that the groove profile s at least of the active groove region 22 of the guide groove 16 is fixed in the groove longitudinal direction 26 by way of parabola sections 28, 30, 32, 34 and/or a spline function, the spline function preferably being an at least second-degree spline function.

In specific terms, the groove profile s of the active groove region 22 of the guide groove 16 according to FIG. 2 in the developed view of the drum body 14 is fixed by way of parabola sections 28, 30, 32, 34. These parabola sections 28, 30, 32, 34 merge in each case directly and without a kink into one another, with the result that the active groove region 22 is fixed exclusively by way of the parabola sections 28, 30, 32, 34 and the groove profile s is continuously differentiable at all points.

In the exemplary embodiment which is shown, even the groove profile s of the entire guide groove 16, including all active groove regions 22 and inactive groove regions 24, is fixed by way of a continuously differentiable function at all points. This is achieved according to FIG. 2 by virtue of the fact that the groove profile s of the inactive groove region 24 of the guide groove 16 is defined by way of a straight piece which extends perpendicularly with respect to the longitudinal axis A and merges into the parabola section 28 in a continuously differentiable manner at a point N₁.

The active groove region 22 of the guide groove 16 is preferably assigned precisely two selectable gears, it being possible for the corresponding selector fork 20 to be moved, starting from a central neutral position, into axially opposed shifting positions.

Each gear is in turn assigned precisely four parabola sections 28, 30, 32, 34 (see FIG. 2), the axial acceleration a of the selector fork 20 being constant within each parabola section 28, 30, 32, 34 on account of the parabola shape. Moreover, the parabola sections 28, 30, 32, 34 are congruent, with the result that the axial acceleration a of the selector fork 20 assumes a value which is constant in terms of magnitude over all parabola sections 28, 30, 32, 34.

As a consequence, the axial displacement of the selector fork 20 during a shifting operation takes place in each case with reduced noise and wear at an acceleration or retardation which is constant in terms of magnitude.

According to FIG. 2, for example starting from a neutral position of the associated selector fork 20, a gear which is assigned to the selector fork 20 which is selected at the point G is engaged at the point N₁ via a first parabola section 28 and a second parabola section 30 of the guide groove 16. Here, during the engaging of the gear, the selector fork 20 first of all experiences a constant acceleration in the area of the first parabola section 28 and subsequently experiences a constant retardation (of identical magnitude) in the area of the second parabola section 30.

Subsequently, the shifted gear is disengaged again via a third parabola section 32 and a fourth parabola section 34 of the guide groove 16, with the result that the selector fork 20 assumes its central neutral position again at a point N₂. In the same way as during the engaging of the gear, the selector fork 20 also experiences, during the disengaging of the gear, first of all a constant acceleration in the area of the third parabola section 32 and subsequently a constant retardation (of identical magnitude) in the area of the fourth parabola section 34.

As a consequence of the axial acceleration a of the selector fork 20 which is constant in terms of magnitude during the shifting operation, the result is a “jolt-free” axial movement, as a result of which noise is minimized and force peaks are avoided in the selector fork 20 and the wear is therefore reduced.

Furthermore, a groove profile s of the guide groove 16 of this type results in high shifting comfort, in particular if the shift transmission 10 is a foot-actuated, sequential shift transmission 10 of a motorcycle.

If, as an alternative, the groove profile s of the active groove region 22 of the guide groove 16 is fixed in the developed view by way of an at least second-degree spline function, the polynomial pieces of the spline function are selected in such a way that, in an analogous manner to FIG. 2, the result is a largely constant profile of the axial acceleration a in sections and undesired force peaks are avoided accordingly. Furthermore, the spline function is preferably selected in such a way that the result is an advantageous continuous profile of the axial acceleration between the largely constant acceleration sections, with the result that acceleration jumps according to FIG. 2 are avoided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A selector drum for a shift transmission of a motor vehicle, comprising:
a substantially cylindrical drum body which is rotatable about a longitudinal axis and has a guide groove on a radial outer side, into which guide groove an actuating pin of a selector fork of the shift transmission is engagable, wherein
the guide groove has an active groove region which defines an axial movement of the selector fork and an inactive groove region which defines an axially fixed neutral position of the selector fork, and
a groove profile of the active groove region of the guide groove is defined by parabola sections and/or a spline function.

2. The selector drum according to in claim 1, wherein
a groove profile of the inactive groove region of the guide groove is defined by a straight line which extends perpendicularly with respect to the longitudinal axis and merges in a continuously differentiable manner into one of the parabola sections and/or the spline function.

3. The selector drum according to claim 1, wherein
a groove profile of the active groove region of the guide groove is defined by parabola sections, the active groove region being assigned at least one selectable gear and each gear being assigned precisely four parabola sections.

4. The selector drum according to claim 2, wherein
a groove profile of the active groove region of the guide groove is defined by parabola sections, the active groove region being assigned at least one selectable gear and each gear being assigned precisely four parabola sections.

5. The selector drum according to claim 1, wherein
a groove profile of the active groove region of the guide groove is defined by parabola sections, all parabola sections being congruent.

6. The selector drum according to claim 4, wherein
a groove profile of the active groove region of the guide groove is defined by parabola sections, all parabola sections being congruent.

7. The selector drum according to claim 1, wherein
a groove profile of the active groove region of the guide groove is defined by an at least second-degree spline function.

8. The selector drum according to claim 2, wherein
a groove profile of the active groove region of the guide groove is defined by an at least second-degree spline function.

9. A shift transmission of a motor vehicle, comprising:
a selector fork of the shift transmission, the selector fork having an actuating pin;
a selector drum for the shift transmission, the selector drum comprising:
a substantially cylindrical drum body which is rotatable about a longitudinal axis and has a guide groove on a radial outer side, into which guide groove the actuating pin of the selector fork of the shift transmission engages, wherein
the guide groove has an active groove region which defines an axial movement of the selector fork and an inactive groove region which defines an axially fixed neutral position of the selector fork, and
a groove profile of the active groove region of the guide groove is defined by parabola sections and/or a spline function.

10. The shift transmission according to claim 9, wherein
a groove profile of the inactive groove region of the guide groove is defined by a straight line which extends perpendicularly with respect to the longitudinal axis and merges in a continuously differentiable manner into one of the parabola sections and/or the spline function.

11. The shift transmission according to claim 10, wherein
a groove profile of the active groove region of the guide groove is defined by parabola sections, the active groove region being assigned at least one selectable gear and each gear being assigned precisely four parabola sections.

12. The shift transmission according to claim 9, wherein
a groove profile of the active groove region of the guide groove is defined by parabola sections, all parabola sections being congruent.

13. The shift transmission according to claim 9, wherein
a groove profile of the active groove region of the guide groove is defined by an at least second-degree spline function.

14. The shift transmission according to claim 9, wherein
the shift transmission is a foot-actuated, sequential shift transmission of a motorcycle.
